(19) United States
(12) Patent Application Publication
(10) Pub. No.: US 2025/0264846 A1
(43) Pub. Date: Aug. 21, 2025

(54) DEVICE WITH A REGULATING MEMBER FOR A TIMEPIECE

(71) Applicant: Chopard Technologies SA, Fleurier (CH)

(72) Inventors: François DE TITTA, Nyon (CH); Pascal PURRO, Genève (CH); Florent ZUFFEREY, Le Grand-Saconnex (CH); Valérie FRANCFORT, Genève (CH); Pierre GEROLD, Froideville (CH)

(21) Appl. No.: 19/046,871

(22) Filed: Feb. 6, 2025

(30) Foreign Application Priority Data
Feb. 21, 2024 (EP) 24158799.7

(51) Int. Cl. G04B 17/06; G04B 17/28

(52) U.S. Cl. CPC G04B 17/063; G04B 17/285

(57) ABSTRACT

The invention relates to a device with a regulating member for a timepiece comprising a frame (2) and a regulating member (3). The regulating member (3) comprises a balance (8) fixedly attached to a staff (9) and first and second balance springs (10, 11). Each of the first and second balance springs (10, 11) has an inner end fixedly attached to one of the staff (9) and frame (2) and an outer end fixedly attached to the other of the staff (9) and frame (2). The staff (9) comprises pivots (14, 15) arranged to rotate in bearings (16, 17) of the frame (2). The first and second balance springs (10, 11) are preloaded so as to exert on the staff (9), parallel to the staff (9), two forces of opposite directions.

The present invention relates to a regulating member of the sprung balance type for a timepiece, and more precisely to a device, such as a movement, a movement part or a tourbillon or karussel, comprising such a regulating member.

In a timepiece, the regulating member is the time base which sets the rate of rotation of the going train. The regulating member generally comprises a balance, i.e. an oscillating inertial member, associated with a spiral return spring called “balance spring” which tends to return the balance to a position of equilibrium. The balance is fixedly attached to a staff which is supported at its two ends by bearings. The inner end of the balance spring is fixed to the staff via a collet and its outer end is fixed to the frame which bears the bearings, wherein the frame is generally stationary but is movable in the case of the tourbillon or karussel. Depending on the direction of rotation of the balance during its oscillations, the balance spring contracts or expands, always looking to return to its rest position corresponding to the position of equilibrium of the balance. In most cases, the balance spring is flat. Nevertheless, its last turn can end in a curve which extends out of the plane of the balance spring and which is shaped such that the centre of gravity of the balance spring remains substantially on the axis of the balance during the oscillations of the regulating member so as to make the deformations of the balance spring concentric, the balance spring thus being called a “Breguet balance spring”. There are also balance springs which, at rest, are not flat but are cylindrical, conical or spherical. In the case of a completely flat balance spring, this is not necessarily shaped like an Archimedean spiral. It can have a variable pitch, a variable cross-section or one or more terminal curves to limit the displacement of the centre of gravity of the balance spring during oscillations of the regulating member and to make the deformations of the balance spring concentric.

An important feature of a regulating member is its quality factor, i.e. the ratio between stored energy and dissipated energy during a period of oscillation. A regulating member with a high quality factor requires less energy to maintain its oscillations at a given amplitude of oscillation. One way of increasing the quality factor consists of reducing the friction of the pivots of the staff in the bearings. For this, for example particular materials having a very low friction coefficient can be used or the geometry of the components can be modified so as to reduce the size of the contacting surfaces. Patent U.S. Pat. No. 3,186,157 describes another solution in which the balance is associated with two flat balance springs, one on each side of the balance, which are strong enough to not only exert their elastic return function but also to axially suspend the balance and thereby decrease the friction in the bearings. However, this solution, proposed more particularly for electric watches in which the oscillations of the regulating member are rapid and small, is disadvantageous in the case of mechanical watches. In fact, in a mechanical watch the oscillation frequency is much lower and the oscillation amplitude is much larger such that, in order to maintain a given oscillation frequency and amplitude the reinforcement of the balance spring (increase in its dimensions or its Young's modulus) should be compensated for by an increase in the inertia of the balance and by an increase in the power provided for maintaining the oscillations, which is contrary to the sought-after aim.

In its introductory part, patent U.S. Pat. No. 3,186,157 mentions the existence in the prior art of another solution for reducing the friction in the bearings, namely a solution consisting of suspending the balance by a magnetic device or a helical spring. The disadvantage of a magnetic device is that it can disrupt operation of the timepiece because several components thereof are sensitive to magnetism. As for the helical spring, this is not described.

The present invention aims to propose a device with a regulating member in which the quality factor of the regulating member is improved by a mechanical solution other than that consisting of increasing the force of the balance spring(s), and more precisely by a mechanical solution which is compatible with the oscillation frequencies and amplitudes found in mechanical timepieces.

For this purpose, the object of the invention is a device with a regulating member for a timepiece comprising a frame and a regulating member, the regulating member comprising a balance fixedly attached to a staff and first and second balance springs, each of the first and second balance springs having an inner end fixedly attached to one of the staff and frame and an outer end fixedly attached to the other of the staff and frame, the staff having pivots arranged to rotate in bearings of the frame, wherein the first and second balance springs are preloaded so as to exert on the staff, parallel to the staff, two forces of opposite directions.

The invention further proposes a timepiece, in particular a mechanical timepiece, comprising such a regulating member.

Other features and advantages of the present invention will become clear upon reading the following detailed description given with reference to the attached drawings in which:

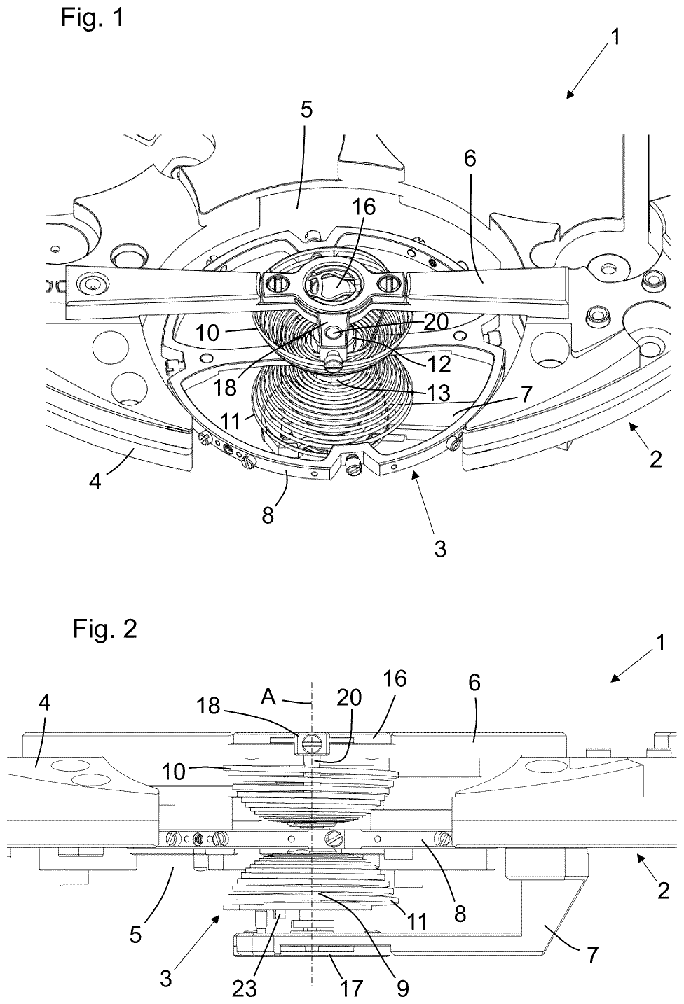

FIG. 1 is a perspective view of part of a device with a regulating member in accordance with the invention;

FIG. 2 is a side view of said part of the device with a regulating member in accordance with the invention;

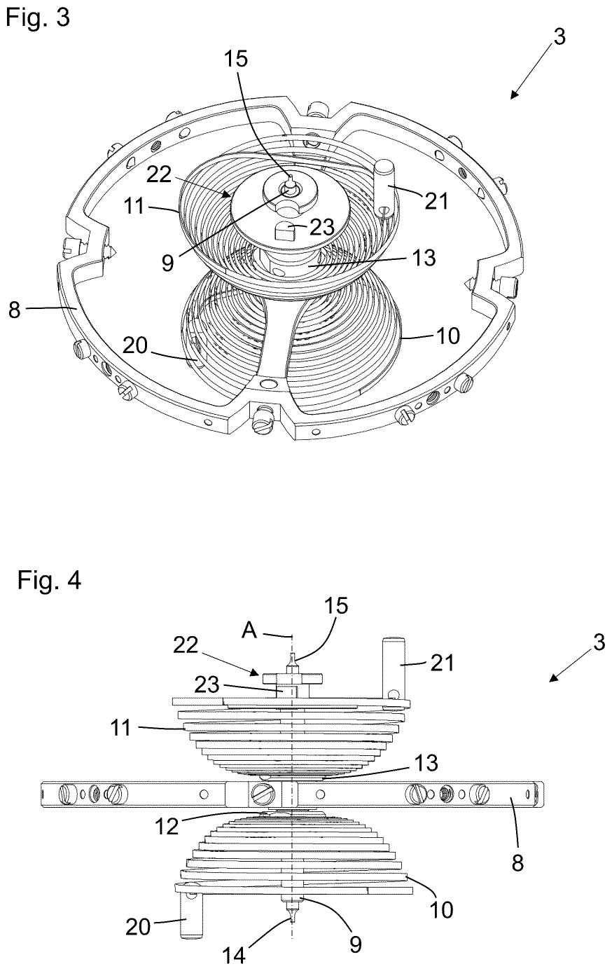

FIG. 3 is a perspective view of the regulating member of the device in accordance with the invention;

FIG. 4 is a side view of the regulating member of the device in accordance with the invention.

With reference to FIGS. 1 to 4, a device with a regulating member 1 in accordance with the invention for a timepiece such as a watch, in particular a wristwatch, and more particularly for a mechanical timepiece, comprises a frame 2 and a regulating member 3 mounted on or in the frame 2. In the illustrated example, the frame 2 is that of the movement of the timepiece and thus forms a fixed part of the timepiece. The frame 2 comprises a plate 4 supporting the movable components of the movement and having a through-opening 5 in which the regulating member 3 is located. The frame 2 further comprises bridges fixed to the plate 4, in particular two balance bridges 6, 7, each in the form of a bar or arm, one fixed to the upper side of the plate 4 and the other fixed to the lower side of the plate 4 and extending above and below the through-opening 5 respectively.

The regulating member 3 comprises a balance 8 fixedly mounted on a staff 9 and two balance springs 10, 11 disposed on both sides of the balance 8 and fixed to the staff 9 by their inner end, via respective collets 12, 13. The balance 8, the staff 9 and the balance springs 10, 11 have a common geometric axis A which forms the axis of rotation of the balance 8-staff 9-collets 12, 13 assembly during operation. The two ends of the staff 9, namely its pivots 14, 15, are arranged to rotate in respective bearings 16, 17 located in the two balance bridges 6, 7. In addition to the bearing 16, 17, each balance bridge 6, 7 has a balance spring stud holder (only one of which, 18, is visible in the drawings) arranged to receive, in a manner which is conventional in itself, a balance spring stud 20, 21, to which the outer end of the corresponding balance spring 10, 11 is fixed. Each balance spring 10, 11 is thereby coupled by its inner end to the staff 9 and by its outer end to the frame 2.

The staff 9 further has, fixedly attached thereto, a double balance roller 22, on which an impulse pin 23 protrudes, said pin being intended to cooperate in a conventional manner with an escapement anchor to maintain the oscillations of the balance 8.

In accordance with the invention, the balance springs 10, 11 are axially preloaded by spaced-apart positions of the inner end and the outer end of each balance spring 10, 11 along the axis A such that two forces parallel to the axis A and acting in opposite directions are exerted on the staff 9 by the balance springs 10, 11. In certain embodiments, the preloading of each balance spring 10, 11 is obtained by moving its inner and outer ends apart from each other along the axis A, with respect to the rest state of the balance spring, by a distance greater than or equal to the height of one turn of the balance spring 10, 11, preferably greater than or equal to the height of several turns of the balance spring 10, 11. In some embodiments, the preloading of each balance spring 10, 11 is obtained by moving its inner and outer ends apart from each other along the axis A, with respect to the rest state of the balance spring, by a distance greater than or equal to 0.1 mm, preferably greater than or equal to 0.2 mm, preferably greater than or equal to 0.5 mm, preferably greater than or equal to 1 mm, preferably greater than or equal to 1.5 mm. Typically, the balance springs 10, 11 each have a convex shape when they are coupled to the staff 9 and to the frame 2, the two convex shapes preferably being portions of a sphere and preferably being symmetrical to each other with respect to a plane perpendicular to the axis A, as can be seen in the drawings.

Prior to being assembled with the staff 9 and the frame 2, the balance springs 10, 11 can be completely flat balance springs, Breguet balance springs (flat balance springs with a terminal curve, or “Phillips curve”, exiting the plane of the balance spring to come closer to the axis of rotation and to return and keep the centre of gravity of the balance spring on the axis of rotation) or other. In accordance with a particularly advantageous example, corresponding to the one shown in the drawings, the balance springs 10, 11, prior to being assembled with the staff 9 and the frame 2, are flat balance springs with a Phillips terminal curve which differ from Breguet balance springs in that the lift of the Phillips curve out of the plane of the balance spring is obtained solely by an elastic deformation of the balance spring, i.e. without a plastic deformation bend, in the manner of the Phillips curves of the cylindrical balance springs. In fact, the axial spacing apart of the inner and outer ends of each balance spring 10, 11 after assembling the latter with the staff 9 and the frame 2 makes it possible to avoid any contact between the Phillips curve and the turns in the axial direction despite the absence of a bend lifting the Phillips curve. Omitting a plastic deformation bend has the advantage that the mechanical properties of the balance spring, in particular the stiffness and the elastic limit, are not adversely affected.

In the illustrated example, the balance spring 10 is axially stretched by the preloading to pull the staff 9 towards the upper balance bridge 6, and the balance spring 11 is stretched axially by the preloading to pull the staff 9 towards the lower balance bridge 7. However, a reverse configuration is possible, where the positions of the inner end and outer end of each balance spring 10, 11 along the axis A would be reversed—for this purpose each balance bridge 6, 7 could comprise an arm which would extend to a point close to the balance 8 so as to fix the outer end of the balance spring 10, 11 to the frame 2 at this point-, and where the axial stretching of the balance spring 10 would have the effect of pulling the staff 9 towards the lower balance bridge 7 and the axial stretching of the balance spring 11 would have the effect of pulling the staff 9 towards the upper balance bridge 6.

The two forces of opposite directions exerted by the balance springs 10, 11 on the staff 9 make it possible to axially suspend the latter, at least partially, and thereby to remove or reduce the axial supporting force of the pivots 14, 15 in the bearings 16, 17 and the resulting friction, this being due to the equilibrium created between these two forces and the axial supporting force of the pivots 14, 15 in the bearings 16, 17. The greater the two forces of opposite directions exerted by the balance springs 10, 11 on the staff 9, the smaller the axial supporting force of the pivots 14, 15 in the bearings 16, 17. Said two forces of opposite directions can have the same strength, for example by being produced by identical balance springs 10, 11, but can also have different strengths.

With respect to traditional balance springs, the balance springs with one or more terminal curves, such as for example the balance springs 10, 11 with a Phillips curve illustrated in the drawings, the Breguet balance springs or the completely flat balance springs of the type described in patent CH 697207 or EP 2138912, have the advantage of being deformed concentrically and, consequently, of reducing the radial supporting forces of the pivots in the bearings and the resulting friction regardless of the angular orientation of the balance springs with respect to each other. For this reason, these balance springs are preferred in the present invention. Nevertheless, the balance springs 10, 11 can be traditional balance springs, without terminal curves making their deformations concentric. However, in this case, they are preferably wound in opposite directions, or are angularly offset by 180° with respect to each other so that the respective radial forces exerted thereby on the staff 9 owing to their eccentric deformations compensate for each other, thereby reducing the radial supporting forces of the pivots 14, 15 in the bearings 16, 17 and the resulting friction.

The present invention has been described above by way of example only. It goes without saying that modifications could be made without departing from the scope of the claimed invention. For example, instead of forming a fixed part of the timepiece, the frame 2 could be a movable frame, for example the cage of a tourbillon or karussel in which the staff 9 and the balance 8 would be axially suspended by the balance springs 10, 11. Another modification could consist of coupling the inner end of the balance springs 10, 11 to the frame 2 rather than to the staff 9 and of coupling the outer end of the balance springs 10, 11 to the balance 8 rather than to the frame 2. Finally, whilst it is preferable, for layout reasons, that the balance springs 10, 11 are arranged on both sides of the balance 8, they could be located on the same side of the balance 8 so long as they exert two forces of opposite directions onto the staff 9, parallel to the staff 9, directly or indirectly.

1. Device with a regulating member for a timepiece comprising a frame and a regulating member, the regulating member comprising a balance fixedly attached to a staff and first and second balance springs, each of the first and second balance springs having an inner end fixedly attached to one of the staff and frame and an outer end fixedly attached to the other of the staff and frame, the staff having pivots arranged to rotate in bearings of the frame, wherein the first and second balance springs are preloaded so as to exert on the staff, parallel to the staff, two forces of opposite directions.

2. Device as claimed in claim 1, wherein the first and second balance springs are arranged on both sides of the balance.

3. Device as claimed in claim 1, wherein the inner end of each of the first and second balance springs is fixedly attached to the staff and the outer end of each of the first and second balance springs is fixedly attached to the frame.

4. Device as claimed in claim 1, wherein each of the first and second preloaded balance springs has a convex shape.

5. Device as claimed in claim 4, wherein the convex shape of each of the first and second preloaded balance springs is the shape of a portion of a sphere.

6. Device as claimed in claim 4, wherein the convex shape of the first balance spring and that of the second balance spring are symmetrical with respect to a plane perpendicular to the staff.

7. Device as claimed in claim 1, wherein each of the first and second balance springs is a balance spring with concentric deformations.

8. Device as claimed in claim 1, wherein each of the first and second balance springs is a flat balance spring with a Phillips curve, to which the preloading has given a convex shape.

9. Device as claimed in claim 8, wherein each of the first and second balance springs is without a plastic deformation bend between the Phillips curve and the rest of the balance spring.

10. Device as claimed in claim 1, wherein the first and second balance springs are wound in opposite directions or are offset by 180° so that the respective radial forces that they exert on the staff owing to eccentric deformations of these balance springs during the oscillations of the regulating member compensate for each other.

11. Device as claimed in claim 1, consisting of a timepiece movement.

12. Device as claimed in claim 1, consisting of a tourbillon or karussel.

13. Timepiece comprising a device as claimed in claim 1.

14. Mechanical timepiece comprising a device as claimed in claim 1.
